(19) United States
(12) Patent Application Publication
(10) Pub. No.: US 2004/0157110 A1
(43) Pub. Date: Aug. 12, 2004

(54) Supported catalysts for the anode of a voltage reversal tolerant fuel cell

(76) Inventors: Shanna D. Knights, Burnaby (CA); Jared L. Taylor, Davis, CA (US); David P. Wilkinson, North Vancouver (CA); Stephen A. Campbell, Maple Ridge (CA)

Correspondence Address: Robert W. Fieseler, McAndrews, Held & Malloy, Ltd., 500 West Madison Street, 34th Floor, Chicago, IL, 60661, US

(21) Appl. No.: 10/689,876

(22) Filed: Oct. 20, 2003

Related U.S. Application Data
(63) Continuation of application No. 09/586,698, filed on Jun. 1, 2000, now abandoned.
(60) Provisional application No. 60/150,253, filed on Aug. 23, 1999.
(60) Provisional application No. 60/171,252, filed on Dec. 16, 1999.

(51) Int. Cl. H01M 4/86; H01M 4/96; H01M 8/10; H01M 4/88

(52) U.S. Cl. 429/44; 429/30; 502/101

(57) ABSTRACT

In a solid polymer fuel cell series, various circumstances can result in a fuel cell being driven into voltage reversal. For instance, cell voltage reversal can occur if that cell receives an inadequate supply of fuel. In order to pass current, reactions other than fuel oxidation may take place at the fuel cell anode, including water electrolysis and oxidation of anode components. The latter may result in significant degradation of the anode, particularly if the anode employs a carbon black supported catalyst. Such fuel cells can be made more tolerant to cell reversal by using higher catalyst loading or coverage on the anode catalyst support or a more oxidation resistant anode catalyst support, such as a more graphitic carbon or Ti₄O₇.

### CROSS-REFERENCE TO RELATED APPLICATION(S)

This application is a continuation of U.S. application Ser. No. 09/586,698, filed Jun. 1, 2000. This application relates to and claims priority benefits from U.S. Provisional Patent Application Serial No. 60/150,253 filed Aug. 23, 1999, and 60/171,252 filed Dec. 16, 1999. Each of the foregoing applications is incorporated by reference herein in its entirety.

### FIELD OF THE INVENTION

The present invention relates to supported catalyst compositions for anodes of solid polymer fuel cells and methods for rendering the fuel cells more tolerant to voltage reversal.

### BACKGROUND OF THE INVENTION

Fuel cell systems are currently being developed for use as power supplies in numerous applications, such as automobiles and stationary power plants. Such systems offer promise of economically delivering power with environmental and other benefits. To be commercially viable, however, fuel cell systems need to exhibit adequate reliability in operation, even when the fuel cells are subjected to conditions outside the preferred operating range.

Fuel cells convert reactants, namely, fuel and oxidant, to generate electric power and reaction products. Fuel cells generally employ an electrolyte disposed between two electrodes, namely a cathode and an anode. A catalyst typically induces the desired electrochemical reactions at the electrodes.

Preferred fuel cell types include solid polymer electrolyte fuel cells that comprise a solid polymer electrolyte and operate at relatively low temperatures.

A broad range of reactants can be used in solid polymer electrolyte fuel cells. For example, the fuel stream may be substantially pure hydrogen gas, a gaseous hydrogen-containing reformate stream, or methanol in a direct methanol fuel cell. The oxidant may be, for example, substantially pure oxygen or a dilute oxygen stream such as air.

During normal operation of a solid polymer electrolyte fuel cell, fuel is electrochemically oxidized at the anode catalyst, typically resulting in the generation of protons, electrons, and possibly other species depending on the fuel employed. The protons are conducted from the reaction sites at which they are generated, through the electrolyte, to electrochemically react with the oxidant at the cathode catalyst. The catalysts are preferably located at the interfaces between each electrode and the adjacent electrolyte.

Solid polymer electrolyte fuel cells employ a membrane electrode assembly (“MEA”), which comprises the solid polymer electrolyte or ion-exchange membrane disposed between the two electrodes. Separator plates, or flow field plates for directing the reactants across one surface of each electrode substrate, are disposed on each side of the MEA.

Each electrode contains a catalyst layer, comprising an appropriate catalyst, located next to the solid polymer electrolyte. The catalyst may be a metal black, an alloy or a supported metal/alloy catalyst, for example, platinum supported on carbon black. Supported catalysts are often preferred as they may provide a relatively high catalyst surface to volume ratio and thus provide for a reduction in the cost of catalyst required. The catalyst layer typically contains ionomer which may be similar to that used for the solid polymer electrolyte (such as, for example, Nafion™). The catalyst layer may also contain a binder, such as polytetrafluoroethylene.

The electrodes may also contain a substrate (typically a porous electrically conductive sheet material) that may be employed for purposes of reactant distribution and/or mechanical support. Optionally, the electrodes may also contain a sublayer (typically containing an electrically conductive particulate material, for example, carbon black) between the catalyst layer and the substrate. A sublayer may be used to modify certain properties of the electrode (for example, interface resistance between the catalyst layer and the substrate, water management).

Electrodes for a MEA can be prepared by first applying a sublayer, if desired, to a suitable substrate, and then applying the catalyst layer onto the sublayer. These layers can be applied in the form of slurries or inks which contain particulates and dissolved solids mixed in a suitable liquid carrier. The liquid carrier is then evaporated off to leave a layer of particulates and dispersed solids. Cathode and anode electrodes may then be bonded to opposite sides of the membrane electrolyte via application of heat and/or pressure, or by other methods. Alternatively, catalyst layers may first be applied to the membrane electrolyte with optional sublayers and substrates incorporated thereafter, either on the catalyzed membrane or an electrode substrate.

In operation, the output voltage of an individual fuel cell under load is generally below one volt. Therefore, in order to provide greater output voltage, numerous cells are usually stacked together and are connected in series to create a higher voltage fuel cell stack. (End plate assemblies are placed at each end of the stack to hold it together and to compress the stack components together. Compressive force is needed for effecting seals and making adequate electrical contact between various stack components.) Fuel cell stacks can then be further connected in series and/or parallel combinations to form larger arrays for delivering higher voltages and/or currents.

Electrochemical cells occasionally are subjected to a voltage reversal condition which is a situation where the cell is forced to the opposite polarity. This may be deliberate, as in the case of certain electrochemical devices known as regenerative fuel cells. (Regenerative fuel cells are constructed to operate both as fuel cells and as electrolyzers in order to produce a supply of reactants for fuel cell operation. Such devices have the capability of directing a water fluid stream to an electrode where, upon passage of an electric current, oxygen is formed. Hydrogen is formed at the other electrode.) However, power-producing electrochemical fuel cells in series are potentially subject to unwanted voltage reversals, such as when one of the cells is forced to the opposite polarity by the other cells in the series. In fuel cell stacks, this can occur when a cell is unable to produce from the fuel cell reactions the current being forced through it by the rest of the cells. Groups of cells within a stack can also undergo voltage reversal and even entire stacks can be driven into voltage reversal by other stacks in an array. Aside from the loss of power associated with one or more cells going into voltage reversal, this situation poses reliability concerns. Undesirable electrochemical reactions may occur, which may detrimentally affect fuel cell components. Component degradation reduces the reliability and performance of the fuel cell.

The adverse effects of voltage reversal can be prevented, for instance, by employing diodes capable of carrying the stack current across each individual fuel cell or by monitoring the voltage of each individual fuel cell and shutting down an affected stack if a low cell voltage is detected. However, given that stacks typically employ numerous fuel cells, such approaches can be quite complex and expensive to implement.

Alternatively, other conditions associated with voltage reversal may be monitored instead, and appropriate corrective action can be taken if reversal conditions are detected. For instance, a specially constructed sensor cell may be employed that is more sensitive than other fuel cells in the stack to certain conditions leading to voltage reversal (for example, fuel starvation of the stack). Thus, instead of monitoring every cell in a stack, only the sensor cell need be monitored and used to prevent widespread cell voltage reversal under such conditions. However, other conditions leading to voltage reversal may exist that a sensor cell cannot detect (for example, a defective individual cell in the stack). Another approach is to employ exhaust gas monitors that detect voltage reversal by detecting the presence of or abnormal amounts of species in an exhaust gas of a fuel cell stack that originate from reactions that occur during reversal. While exhaust gas monitors can detect a reversal condition occurring within any cell in a stack and they may suggest the cause of reversal, such monitors do not identify specific problem cells and they do not generally provide any warning of an impending voltage reversal.

Instead of or in combination with the preceding, a passive approach may be preferred such that, in the event that reversal does occur, the fuel cells are either more tolerant to the reversal or are controlled in such a way that degradation of any critical hardware is reduced. A passive approach may be particularly preferred if the conditions leading to reversal are temporary. If the cells can be made more tolerant to voltage reversal, it may not be necessary to detect for reversal and/or shut down the fuel cell system during a temporary reversal period. Co-owned U.S. Provisional Patent Application Serial No. 60/150,253, entitled “Fuel Cell Anode Structures For Voltage Reversal Tolerance”, filed Aug. 23, 1999, discloses various anode structures that provide for improved voltage reversal tolerance. Co-owned U.S. patent application Ser. No. 09/404,897, entitled “Solid Polymer Fuel Cell With Improved Voltage Reversal Tolerance”, filed Sep. 24, 1999, discloses various catalyst compositions that provide for improved voltage reversal tolerance.

### SUMMARY OF THE INVENTION

During voltage reversal, electrochemical reactions may occur that result in the degradation of certain components in the affected fuel cell. Depending on the reason for the voltage reversal, there can be a rise in the absolute potential of the fuel cell anode. This can occur, for instance, when the reason is an inadequate supply of fuel (that is, fuel starvation). During such a reversal in a solid polymer fuel cell, water present at the anode may be electrolyzed and oxidation (corrosion) of the anode components, particularly carbonaceous catalyst supports if present, may occur. It is preferred to have water electrolysis occur rather than component oxidation. When water electrolysis reactions at the anode cannot consume the current forced through the cell, the rate of oxidation of the anode components increases, thereby tending to irreversibly degrade certain anode components at a greater rate. A solid polymer electrolyte fuel cell can be made more tolerant to voltage reversal by employing supported catalyst compositions at the anode which are more resistant to oxidative corrosion.

A typical solid polymer electrolyte fuel cell comprises a cathode, an anode, a solid polymer electrolyte, an oxidant fluid stream directed to the cathode and a fuel fluid stream directed to the anode. In a reversal tolerant fuel cell, the anode comprises a corrosion resistant supported catalyst. The anode catalyst is typically selected from the group consisting of precious metals, transition metals, oxides thereof, alloys thereof, and mixtures thereof. The corrosion resistant supported catalyst may be obtained by increasing the loading of catalyst on a conventional support thereby covering a greater portion of the surface of the support with catalyst and also decreasing the relative perimeter of the exposed interface between catalyst and support (that is, the perimeter of the catalyst/support interface that is exposed per unit weight of catalyst). Alternatively, the corrosion resistant supported catalyst may be obtained by using an unconventional material having greater corrosion resistance as a support.

Conventional catalyst supports include acetylene or furnace carbon blacks. In the case of platinum catalysts supported on such carbon blacks, a loading of about 40% platinum or more by weight of the supported catalyst represents a greater loading that provides improved voltage reversal tolerance. In a like manner, a catalyst coverage of significantly greater than 6% (and preferably greater than about 9%) of the support surface or a relative catalyst/support interface perimeter of significantly less than 10¹¹ m/g (and preferably less than about 4×10¹⁰ m/g) can also provide improved voltage reversal tolerance.

Unconventional materials that have greater corrosion resistance than acetylene or furnace carbon blacks include graphite or other carbons that are more graphitic than these carbon blacks, including graphitized versions of these carbon blacks. A way of indicating the degree of graphitization of a carbon is by the carbon inter-layer separation d₀₀₂ as determined by x-ray diffraction. The d₀₀₂ spacing of a typical acetylene or furnace carbon black may be about 3.56 Å. Thus, carbons having smaller d₀₀₂ spacings may be suitable as more corrosion resistant supports. Such carbons may have smaller surface areas however than conventional carbon blacks (for example, less than about 230 m²/g as determined by a BET nitrogen adsorption method). Alternatively, other unconventional materials such as Ebonex® (Ti₄O₇) and the like may also be suitable as more corrosion resistant supports than conventional carbon blacks.

### BRIEF DESCRIPTION OF THE DRAWINGS

FIG. 1 is a schematic diagram of a solid polymer fuel cell.

FIG. 2a shows a representative plot of voltage as a function of time, as well as representative plots of current consumed generating carbon dioxide and oxygen as a function of time, for a conventional solid polymer fuel cell undergoing fuel starvation.

FIG. 2b shows comparative plots of representative voltage as a function of time for conventional solid polymer fuel cells comprising unsupported and supported anode catalysts while undergoing fuel starvation.

FIGS. 3a, 3b and 3c show the initial cyclic voltammetry sweeps for cells comprising 10%, 20% and 40% platinum loaded carbon black anode catalysts respectively in Example 1.

FIG. 3d shows the cyclic voltammetry sweep for the cell comprising 10% platinum loaded carbon black anode catalyst after 5 cycles.

FIG. 4a shows the time to anode deactivation as a function of percentage platinum loading in Example 2.

FIG. 4b shows the polarization data before and after reversal testing for 20% and 40% loading platinum respectively.

FIGS. 5a and 5b show plots of voltage as a function of time, as well as the current consumed in the production of CO₂ as a function of time, respectively, during the voltage reversal period for cells S, V, and VG in Example 3.

### DETAILED DESCRIPTION OF PREFERRED EMBODIMENTS

Voltage reversal occurs when a fuel cell in a series stack cannot generate the current provided by the rest of the cells in the series stack. Several conditions can lead to voltage reversal in a solid polymer fuel cell, including insufficient oxidant, insufficient fuel, insufficient water, low or high cell temperatures, and certain problems with cell components or construction. Reversal generally occurs when one or more cells experience a more extreme level of one of these conditions compared to other cells in the stack. While each of these conditions can result in negative fuel cell voltages, the mechanisms and consequences of such a reversal may differ depending on which condition caused the reversal.

During normal operation of a solid polymer fuel cell on hydrogen fuel, the following electrochemical reactions take place:

At the anode: H₂→2H⁺+2e⁻

At the cathode: 1/2O₂+2H⁺+2e⁻→H₂O

Overall: H₂+1/2O₂→H₂O

However, with insufficient oxidant (oxygen) present, the protons produced at the anode cross the electrolyte and combine with electrons directly at the cathode to produce hydrogen gas. The anode reaction and thus the anode potential remain unchanged. However, the absolute potential of the cathode drops and the reaction is

At the cathode, in the absence of oxygen:

2H⁺+2e⁻→H₂

In this case, the fuel cell is operating like a hydrogen pump. Since the oxidation of hydrogen gas and the reduction of protons are both very facile (that is, small overpotential), the voltage across the fuel cell during this type of reversal is quite small. Hydrogen production actually begins at small positive cell voltages (for example, 0.03 V) because of the large hydrogen concentration difference present in the cell. The cell voltage observed during this type of reversal depends on several factors (including the current and cell construction) but, at current densities of about 0.5 A/cm², the fuel cell voltage may typically be greater than or about −0.1 V.

An insufficient oxidant condition can arise when there is water flooding in the cathode, oxidant supply problems, and the like. Such conditions then lead to low magnitude voltage reversals with hydrogen being produced at the cathode. Significant heat is also generated in the affected cell(s). These effects raise potential reliability concerns, however the low potential experienced at the cathode does not typically pose a significant corrosion problem for the cathode components. Nonetheless, some degradation of the membrane might occur from the lack of water production and from the heat generated during reversal. Also, the continued production of hydrogen may result in some damage to the cathode catalyst.

A different situation occurs when there is insufficient fuel present. In this case, the cathode reaction and thus the cathode potential remain unchanged. However, the anode potential rises to the potential for water electrolysis. Then, as long as water is available, some electrolysis takes place at the anode. However, the potential of the anode is then generally high enough to start significantly oxidizing typical components used in the anode, for example, the carbons employed as supports for the catalyst or the electrode substrate materials. Thus, some anode component oxidation typically occurs along with electrolysis. (Thermodynamically, oxidation of carbon components actually starts to occur before electrolysis. However, it has been found that electrolysis appears kinetically preferred and thus proceeds at a greater rate.) The reactions in the presence of oxidizable carbon-based components are typically:

At the anode, in the absence of fuel:

H₂O→1/2O₂+2H⁺+2e⁻

and

1/2C+H₂O→1/2CO₂+2H⁺+2e⁻

More current can be sustained by the electrolysis reaction if sufficient water is available at the anode catalyst layer. However, if not consumed in the electrolysis of water, current is instead used in the corrosion of the anode components. If the supply of water at the anode runs out, the anode potential rises further and the corrosion rate of the anode components increases. Thus, there is preferably an ample supply of water at the anode in order to prevent degradation of the anode components during reversal.

The voltage of a fuel cell experiencing fuel starvation is generally much lower than that of a fuel cell receiving insufficient oxidant. During reversal from fuel starvation, the cell voltage ranges around −1 V when most of the current is carried by water electrolysis. However, when electrolysis cannot sustain the current (for example, if the supply of water runs out or is inaccessible), the cell voltage can drop substantially (that is, much less than −1 V) and is theoretically limited only by the voltage of the remaining cells in the series stack. Current is then carried by corrosion reactions of the anode components or through electrical shorts which may develop as a result. Additionally, the cell may dry out, leading to very high ionic resistance and further heating. The impedance of the reversed cell may increase such that the cell is unable to carry the current provided by the other cells in the stack, thereby further reducing the output power provided by the stack.

Fuel starvation can arise when there is severe water flooding at the anode, fuel supply problems, and the like. Such conditions may then lead to high magnitude voltage reversals (that is, much less than −1 V) with oxygen being produced at the anode. Significant heat is again generated in the reversed cell. These effects raise more serious reliability concerns than an oxidant starvation condition. Very high potentials may be experienced at the anode thereby posing a serious anode corrosion and hence reliability concern.

Voltage reversals may also originate from low fuel cell temperatures, for example at start-up. Cell performance decreases at low temperatures for kinetic, cell resistance, and mass transport limitation reasons. Voltage reversal may then occur in a cell whose temperature is lower than the others due to a temperature gradient during start-up. Reversal may also occur in a cell because of impedance differences that are amplified at lower temperatures. However, when voltage reversal is due solely to such low temperature effects, the normal reactants are generally still present at both the anode and cathode (unless, for example, ice has formed so as to block the flowfields). In this case, voltage reversal is caused by an increase in overpotential only. The current forced through the reversed cell still drives the normal reactions to occur and thus the aforementioned corrosion issues arising from a reactant starvation condition are less of a concern. (However, with higher anode potentials, anode components may also be oxidized.) This type of reversal is primarily a performance issue which is resolved when the stack reaches a normal operating temperature.

Problems with certain cell components and/or construction can also lead to voltage reversals. For instance, a lack of catalyst on an electrode due to manufacturing error would render a cell incapable of providing normal output current. Similarly degradation of catalyst or another component for other reasons could render a cell incapable of providing normal output current.

In the present approach, fuel cells are rendered more tolerant to voltage reversal by employing corrosion resistant supported catalysts at the anode. This approach is particularly advantageous during fuel starvation conditions.

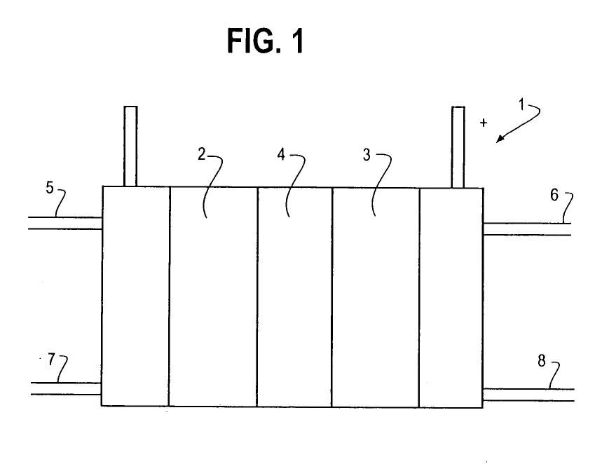

FIG. 1 shows a schematic diagram of a solid polymer fuel cell. Solid polymer fuel cell 1 comprises anode 2, cathode 3, and solid polymer electrolyte 4. The cathode typically employs catalyst supported on carbon powder that is mounted in turn upon a porous carbonaceous substrate. The anode here employs a corrosion resistant supported catalyst that is also mounted upon a porous carbonaceous substrate. A fuel stream is supplied at fuel inlet 5 and an oxidant stream is supplied at oxidant inlet 6. The reactant streams are exhausted at fuel and oxidant outlets 7 and 8 respectively. In the absence of fuel, water electrolysis and oxidation of any carbon components or other oxidizable components in the anode may occur.

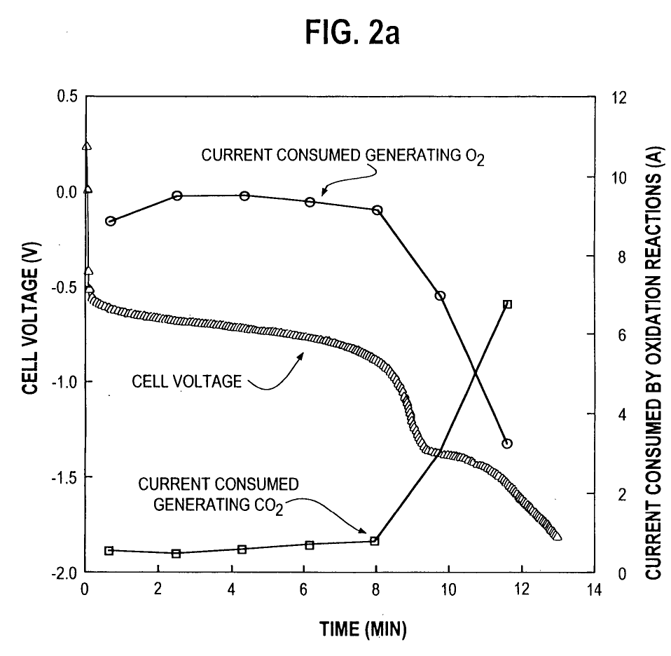

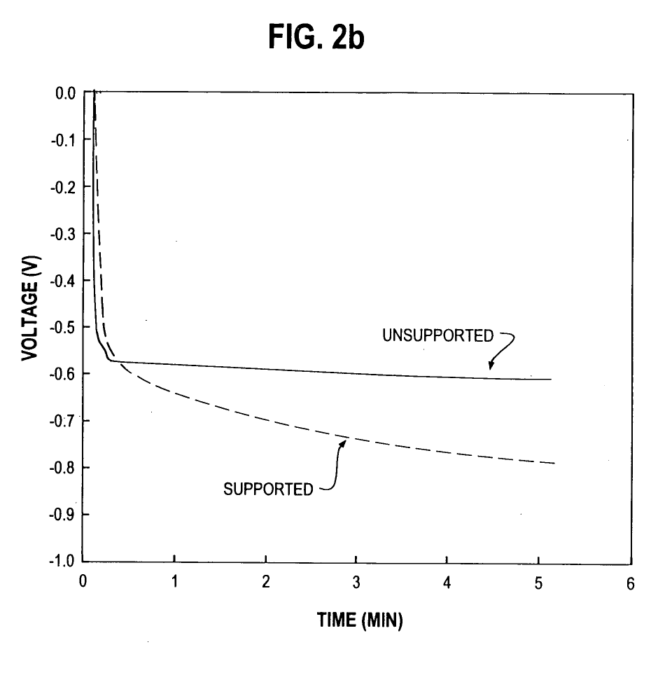

FIG. 2a shows a representative plot of voltage as a function of time for a conventional solid polymer fuel cell undergoing fuel starvation. (The fuel cell anode and cathode comprised carbon black-supported platinum/ruthenium and platinum catalysts respectively on carbon fibre paper substrates.) In this case, a stack reversal situation was simulated by using a constant current (10 A) power supply to drive current through the cell, and a fuel starvation condition was created by flowing humidified nitrogen (100% relative humidity (RH)) across the anode instead of the fuel stream. The exhaust gases at the fuel outlet of this conventional fuel cell were analyzed by gas chromatography during the simulated fuel starvation. The rates at which oxygen and carbon dioxide appeared in the anode exhaust were determined and used to calculate the current consumed in producing each gas also shown in FIG. 2a.

As shown in FIG. 2a, the cell quickly went into reversal and dropped to a voltage of about −0.6 V. The cell voltage was then roughly stable for about 8 minutes, with only a slight increase in overvoltage with time. During this period, most of the current was consumed in the generation of oxygen via electrolysis (H₂O→1/2O₂+2H⁺+2e⁻). A small amount of current was consumed in the generation of carbon dioxide (1/2C+H₂O→1/2CO₂+2H⁺+2e⁻). The electrolysis reaction thus sustained most of the reversal current during this period at a rough voltage plateau from about −0.6 V to about −0.9 V. At that point, it appeared that electrolysis could no longer sustain the current and the cell voltage dropped abruptly to about −1.4 V. Another voltage plateau developed briefly, lasting about 2 minutes. During this period, the amount of current consumed in the generation of carbon dioxide increased rapidly, while the amount of current consumed in the generation of oxygen decreased rapidly. On this second voltage plateau therefore, significantly more carbon was oxidized in the anode than on the first voltage plateau. After about 11 minutes, the cell voltage dropped off quickly again. Typically thereafter, the cell voltage continued to fall rapidly to very negative voltages (not shown) until an internal electrical short developed in the fuel cell (representing a complete cell failure). Herein, the inflection point at the end of the first voltage plateau is considered as indicating the end of the electrolysis period. The inflection point at the end of the second plateau is considered as indicating the point beyond which complete cell failure can be expected.

Without being bound by theory, the electrolysis reaction observed at cell voltages between about −0.6 V and about −0.9 V is presumed to occur because there is water present at the anode catalyst and the catalyst is electrochemically active. The end of the electrolysis plateau in FIG. 2a may indicate an exhaustion of water in the vicinity of the catalyst or loss of catalyst activity (for example, by loss of electrical contact to some extent). The reactions occurring at cell voltages of about −1.4 V would presumably require water to be present in the vicinity of anode carbon material without being in the vicinity of, or at least accessible to, active catalyst (otherwise electrolysis would be expected to occur instead). The internal shorts that develop after prolonged reversal to very negative voltages appear to stem from severe local heating which occurs inside the membrane electrode assembly, which may melt the polymer electrolyte, and create holes that allow the anode and cathode electrodes to touch.

In practice, a minor adverse effect on subsequent fuel cell performance may be expected after the cell has been driven into the electrolysis regime during voltage reversal (that is, driven onto the first voltage plateau). For instance, a 50 mV drop may be observed in subsequent output voltage at a given current for a fuel cell using carbon black-supported anode catalyst. More of an adverse effect on subsequent fuel cell performance (for example, 150 mV drop) will likely occur after the cell has been driven into reversal onto the second voltage plateau. Beyond that, complete cell failure can be expected as a result of internal shorting. It has been found however that fuel cells using unsupported anode catalysts, for example platinum blacks, are less degraded when subjected to cell reversal. For example, FIG. 2b compares representative plots of voltage as a function of time for conventional solid polymer fuel cells comprising either supported or unsupported anode catalysts during fuel starvation. (Except that one cell employed an unsupported anode catalyst and the other cell was driven at a slightly greater 12 A current in this particular instance, the cell construction and starvation simulation were similar to those in FIG. 2a.) Thus, at least with respect to voltage reversals of this kind, unsupported metal or alloy anode catalysts appear preferred over supported anode catalysts. Nonetheless, the use of supported catalysts may be desirable for other reasons, particularly for obtaining a relatively high catalyst surface to volume ratio and thus for cost reduction. Overall, it may therefore be preferable to employ a supported anode catalyst that is more corrosion resistant and hence more tolerant to voltage reversal.

Two methods have been identified for rendering a supported anode catalyst more resistant to oxidative corrosion. In the first method, the catalyst loading or coverage on the support is increased. Conventionally, a loading or coverage on a supported catalyst is employed that provides a desirable catalyst surface to volume ratio. However, by increasing the loading, the surface of the support is covered with more catalyst thus inhibiting or impeding access of water to the support and hence corrosion. As coverage increases, the supported catalyst effectively behaves more like an unsupported catalyst insofar as corrosion is concerned. In addition, increasing the loading results in a relative reduction in the perimeter of the interface between catalyst and support that is exposed in the fuel cell. As illustrated in the Examples to follow, the catalyst may also catalyze corrosion of the support during reversal. Thus, regions on the support near these catalyst/support interfaces may be susceptible to more rapid corrosion than regions that are remote from the catalyst. Accordingly, reducing the relative perimeter of these interfaces per unit amount of catalyst may also reduce corrosion. Such a reduction may be most significant during periods of reversal at relatively low anode overpotentials. At higher anode overpotentials, catalyst may no longer be required for rapid oxidation of the support to occur.

Known methods may be employed to increase the catalyst coverage of the support. Ideally perhaps, the support surface might be completely coated with a thin, high surface area deposit of catalyst. However, with conventional synthesis techniques, the extent to which the support is covered by catalyst typically levels off with increased loading before the support is completely covered. Attempts at further catalyst deposition result in the additional catalyst being deposited upon deposited catalyst and not the support. At this point, a gain in corrosion resistance may not be obtained with additional catalyst loading and further catalyst deposition may be counterproductive overall.

In general, this method may involve a trade-off with regards to catalyst surface/volume ratio. However, the benefits gained with regards to voltage reversal tolerance may outweigh a slight increase in the total amount of catalyst required to maintain fuel cell performance.

In the second method for rendering a supported anode catalyst more resistant to oxidative corrosion, more corrosion resistant materials are used as the anode catalyst supports. Instead of the typical acetylene or furnace black, a more graphitic carbon or simply a graphitized version of the otherwise typical carbon black may be employed. Graphitization can be performed by heating the desired carbon in a furnace at high temperatures (for example, greater than about 2000° C.) under an inert atmosphere. The inter-layer separation d₀₀₂ in the crystalline structure of the carbon is indicative of the extent of graphitization and can be determined by x-ray diffraction. The carbon blacks commonly used as conventional catalyst supports have d₀₀₂ spacings of about 3.56 Å. Thus, carbons having significantly smaller d₀₀₂ spacings than this would be expected to provide improved corrosion resistance. The corrosion resistance of potentially suitable carbon supports can be evaluated electrochemically using standard methods (for example, by measuring corrosion current as the potential of an electrode comprising the sample support is varied in an environment analogous to that in a solid polymer fuel cell. Note however, as illustrated in Example 1 below, in determining corrosion rates based on ex-situ tests of the support alone, the support oxidizes or corrodes much more quickly in the presence of catalyst.

Alternatively, a material other than carbon might be used as a corrosion resistant support. For instance, Ebonex® (Ti₄O₇) particles are suitable for consideration as a support and may offer improved corrosion resistance in fuel cell applications (see A. Hamnett et al., Journal of Applied Electrochemistry, 21 (1991), pages 982-985). However, when using alternative materials such as Ebonex® or when using different or more graphitized carbons, attention must be paid to the surface area of the support. Conventional carbon black supports are employed in part because they are characterised by relatively large surface areas. It may be difficult to obtain the same surface area in supports made using more corrosion resistant materials. Again, while a trade-off in this regard may be required, the benefits gained with regards to voltage reversal tolerance may outweigh any disadvantage resulting from a lower surface area of the support.

Along with improving the corrosion resistance of the supported anode catalyst, other modifications might desirably be adopted to improve tolerance to voltage reversal. For instance, other component and/or structural modifications to the anode may be useful in providing and maintaining more water in the vicinity of the anode catalyst during voltage reversal. The use of an ionomer with a higher water content in the catalyst layer would be an example of a component modification that would result in more water in the vicinity of the anode catalyst. Tolerance to voltage reversal might also be improved by employing an anode catalyst composition that enhances electrolysis during reversal.

The following examples illustrate certain embodiments and aspects of the invention. However, these examples should not be construed as limiting in any way.

### EXAMPLE 1

A series of membrane electrode assemblies (MEAs) was constructed for laboratory testing using test electrodes with carbon black supported platinum catalysts having varied platinum loading on the supports. The series consisted of cells whose test electrodes had catalysts with platinum loading of 0, 10, 20, and 40% of the total weight on Vulcan XC72R grade furnace black (from Cabot Carbon Ltd., South Wirral, U.K.). In preparing the test electrodes, a catalyst sample was applied as a layer in the form of an aqueous ink on a porous carbon substrate using a screen printing method. The aqueous inks comprised catalyst sample, ion conducting ionomer, and a binder. With the exception of the 0% platinum loaded sample, each test electrode was prepared with the same weight of platinum per unit area. Thus, test electrodes with lower platinum loading on the supports contained a greater weight of carbon black support. Further, test electrodes with lower platinum loading on the supports also had a higher platinum surface area per gram of platinum, presumably due to the nature of the platinum deposit on the support.

Table 1 following lists various measured and calculated physical properties for 10%, 20%, and 40% platinum loaded supports prepared similarly to the preceding. In Table 1, the exposed platinum surface area and the size of the supported platinum crystallites were determined in different ways. One set of values was provided by the manufacturer of the carbon supported platinum samples. The size of the crystallites in this set of values was determined from x-ray diffraction patterns. Another set of values was obtained from measurements of the platinum electrochemical surface area, ECA, and from use of an empirically derived relation for supported platinum catalysts in Carbon, Electrochemical and Physicochemical Properties, K. Kinoshita, 1988, John Wiley & Sons, pages 390-391. The ECA values were first determined by conventional liquid CO stripping voltammetry in an ex-situ (that is, not in a fuel cell) test configuration. The number of platinum crystallites per unit weight of catalyst, N, was then derived using the aforementioned relation

A=N^{1/3}ρ^{-2/3}W^{2/3}

where A is the ECA, p is the density of platinum (21.45 g/cc) and W is the loading fraction (dimensionless). Then, assuming hemispherically deposited platinum crystallites, the average crystallite diameter (size) of the platinum hemispheres was finally derived using simple geometry and the preceding values of N, ρ, and W.

Using each set of platinum surface area and crystallite size values along with data provided by the manufacturer for the BET surface area of the carbon supports, Table 1 also shows calculated values for the percentage of the carbon support covered by platinum and for the perimeter of exposed platinum/carbon interface per gram of platinum. Again, these calculations were based on simple geometrical considerations assuming hemispherically deposited crystallites. The total volume of platinum and the average crystallite diameter were used to derive these values in a first set of calculations. The total surface area of platinum exposed and the average crystallite diameter were used to derive values in a second set of calculations. (In both sets of calculations, the platinum was assumed to deposit on the carbon support as hemispheres. Because the platinum crystallite size is much smaller than the size of the carbon support, the interfaces between the platinum crystallites and the carbon supports were assumed to be essentially planar. Thus, each crystallite was assumed to cover a circular area on the carbon support surface with a diameter equal to the crystallite size. The exposed platinum/carbon interface perimeter would then be equal to the circumference defined by the circular area. In the first set of calculations, the number of crystallites was calculated from the total volume of platinum and the average crystallite diameter. Then the platinum circular areas and circumferences contacting the carbon supports were calculated using this number of crystallites. In the second set of calculations, the number of crystallites was calculated from the total surface area of platinum exposed to the electrolyte, the average crystallite diameter, and the loading. Then the platinum circular areas and circumferences contacting the carbon supports were calculated using this other number of crystallites.) Also shown in Table 1 is the percentage platinum coverage on the carbon support ignoring any surface area arising from micropores (that is, pores less than about 100 nanometers in diameter) of the support. Since it is likely that neither platinum deposits nor electrolyte may access the surface in these micropores, such surface may be irrelevant with regards to relative platinum coverage and to corrosion.

As shown in Table 1, there is generally good agreement in the values determined by the various approaches used. At greater loading, the platinum covers substantially more of the surface of the carbon support. Additionally, at greater loading, the exposed platinum/carbon interface perimeter per gram of platinum is substantially reduced.

TABLE 1

| | | | | ECA and | |
|---|---|---|---|---|---|
| Source of platinum | | | | calculation | |
| surface area and | | | | (after | |
| crystallite | | | | determining | |
| diameter | Manufacturer | | | N) | |
| Loading fraction W | 0.1 | 0.2 | 0.4 | 0.2 | 0.4 |
| Exposed platinum | 140 | 110 | 65 | 118 | 76 |
| surface area | | | | | |
| (m²/g) | | | | | |
| Crystallite | 2.3 | 2.6 | 3.7 | 2.1 | 5.1 |
| diameter (nm) | | | | | |
| Total BET surface | 231 | 231 | 231 | 228 | 228 |
| area of carbon | | | | | |
| support | | | | | |
| (m²/g of C) | | | | | |
| BET surface area | 133 | 133 | 133 | 133 | 133 |
| of micropores in | | | | | |
| carbon support | | | | | |
| (m²/g of C) | | | | | |

First set of calculated values (using the total volume of
platinum and the average crystallite diameter)

| | | | | | |
|---|---|---|---|---|---|
| Total support | 3% | 6% | 11% | 7% | 8% |
| surface area | | | | | |
| covered by | | | | | |
| platinum | | | | | |
| Support surface | 7% | 14% | 26% | 18% | 19% |
| area excluding | | | | | |
| micropores covered | | | | | |
| by platinum | | | | | |
| Platinum/carbon | 11 | 8.3 | 4.1 | 13 | 2.2 |
| interface | | | | | |
| perimeter (m * 10¹⁰) | | | | | |
| per gram platinum | | | | | |

Second set of calculated values (using the total surface area
of exposed platinum and the average crystallite diameter)

| | | | | | |
|---|---|---|---|---|---|
| Total support surface | 3% | 6% | 9% | 6% | 11% |
| area covered by | | | | | |
| platinum | | | | | |
| Support surface area | 8% | 14% | 22% | 16% | 27% |
| excluding micropores | | | | | |
| covered by platinum | | | | | |
| Platinum/carbon | 12 | 8.5 | 3.5 | 12 | 3.0 |
| interface perimeter | | | | | |
| (m * 10¹⁰) per gram | | | | | |
| platinum | | | | | |

In the laboratory testing, the test electrodes were evaluated opposite a reference electrode (that is, dynamic hydrogen electrode or DHE). The reference electrodes in this series of MEAs employed platinum/ruthenium alloy catalyst supported on Vulcan XC72R grade carbon black and were applied to a porous carbon substrate. The membranes in this series of MEAs were Dowpont™ experimental perfluorinated solid polymer membrane. The effective platinum surface area (EPSA) of each test electrode was then determined by conventional CO stripping cyclic voltammetry (CV). The test electrodes were supplied with nitrogen gas and served as cathodes in this CV testing. The DHEs were supplied with hydrogen gas and served as anodes. (The EPSA is a dimensionless electrochemical parameter defined as the catalyst electrochemical surface area (ECA) divided by the geometric area of the test electrode. The EPSA is also determined by CO stripping voltammetry but it is performed in-situ (that is, in a fuel cell). Thus, ECA more closely measures the total catalyst surface area that is accessed by CO while EPSA measures the catalyst surface that is accessed both by CO and a fuel cell electrolyte.)

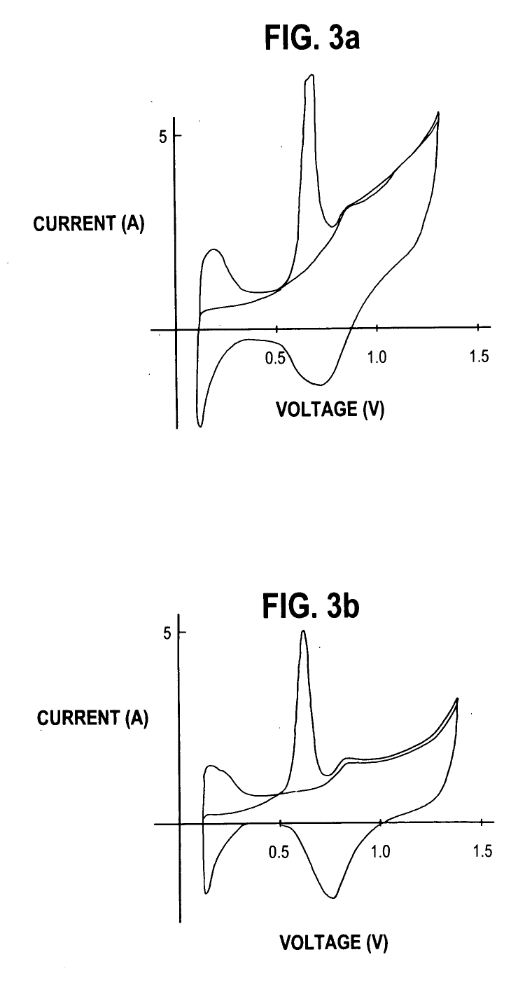

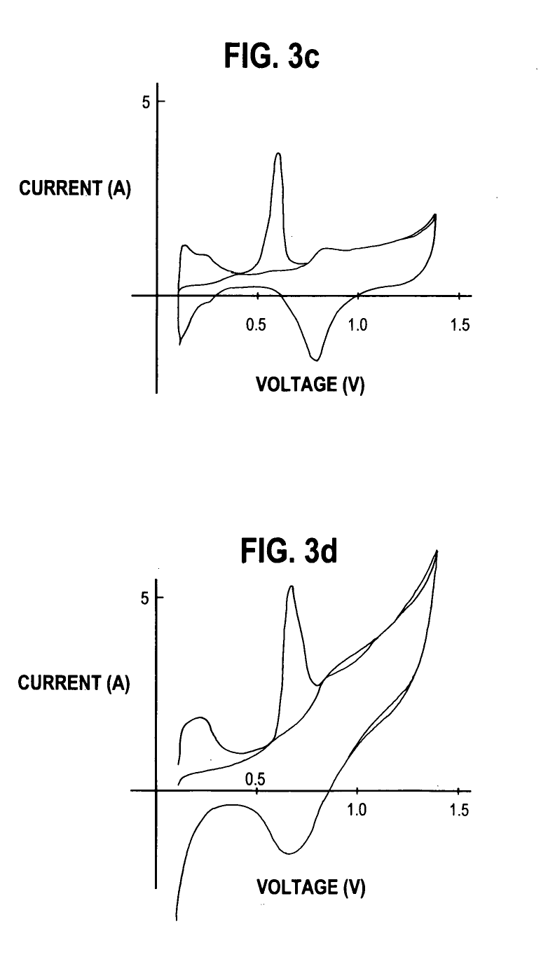

However, in the EPSA determinations, corrosion of the carbon black supports was also observed. FIGS. 3a, 3b and 3c show the initial CV sweeps, at 20 mV/s, for the cells comprising the 10%, 20%, and 40% platinum loaded carbon black catalysts respectively. FIG. 3d shows the CV sweep for the cell comprising the 10% platinum loaded carbon black catalyst after 5 cycles. Not shown is the CV sweep for the cell comprising 40% loaded carbon black which was also cycled 5 times but whose CV sweep was indistinguishable from that of FIG. 3a. Also not shown is the CV sweep for the cell comprising 0% loaded carbon black which showed no significant current (that is, flat line sweep) over the same voltage range. In each of FIGS. 3a, 3b and 3c, the CO stripping peak is observed between about 0.6 and about 0.7 volts. Also however, large positive currents representative of carbon oxidation are seen in FIG. 3a over the range from about 0.8 to about 1.4 volts. In FIGS. 3b and 3c, both the CO stripping peak and the carbon oxidation currents decrease (with increasing platinum loading), but qualitatively the carbon oxidation currents decrease more quickly than the CO peak as the platinum loading on the support increases. In FIG. 3d, the CO stripping peak of the 10% platinum loaded test electrode is markedly reduced compared to that in FIG. 3a, suggesting a loss of catalyst after cycling (that is, reversal). However, the higher (40%) platinum loaded test electrode indicated no significant change in CO stripping peak magnitude after similar cycling, suggesting no significant loss of catalyst.

Since the 0% loaded carbon black shows no significant corrosion current under these conditions, it appears that deposited platinum is required to catalyze the observed carbon corrosion. Importantly, even though a lower platinum loading on the support appears preferred in terms of electrochemical surface area per gram of platinum (ECA), a higher platinum loading and platinum coverage of the support appears preferable in terms of reducing corrosion of the carbon support and in reducing catalyst loss.

### EXAMPLE 2

A series of solid polymer fuel cells was constructed using MEAs similar to those in Example 1 above. However, the test electrodes were now the anodes and had catalysts with platinum loading of 0, 10, 20, and 40% of the total weight on Vulcan XC72R grade furnace black. The opposing electrodes, that is, the cathodes, employed platinum black (unsupported) catalyst applied to a porous carbon substrate. Each cell was electrically conditioned by operating it normally at a current density of about 0.5 A/cm² and a temperature of approximately 75° C. Humidified hydrogen was used as fuel and humidified air as the oxidant, both at 30 psig pressure. The stoichiometry of the reactants (that is, the ratio of reactant supplied to reactant consumed in the generation of electricity) was 1.5 and 2 for the hydrogen and oxygen reactants respectively. After conditioning, the output cell voltage as a function of current density (polarization data) was determined on the cells with 20% and 40% platinum loading before subjecting them to voltage reversal. This polarization data was obtained using both pure oxygen and air as the oxidant supply. All the cells were then subjected to voltage reversal testing.

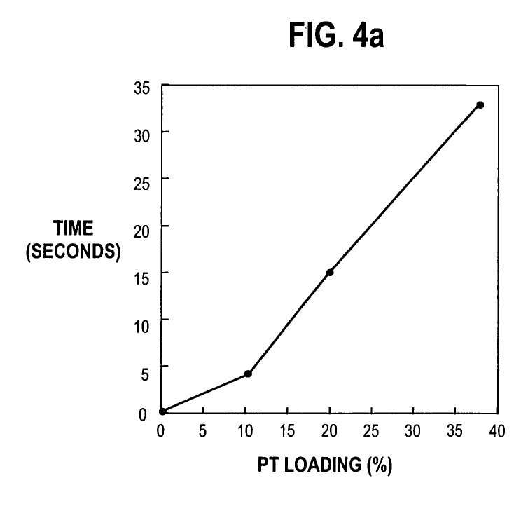

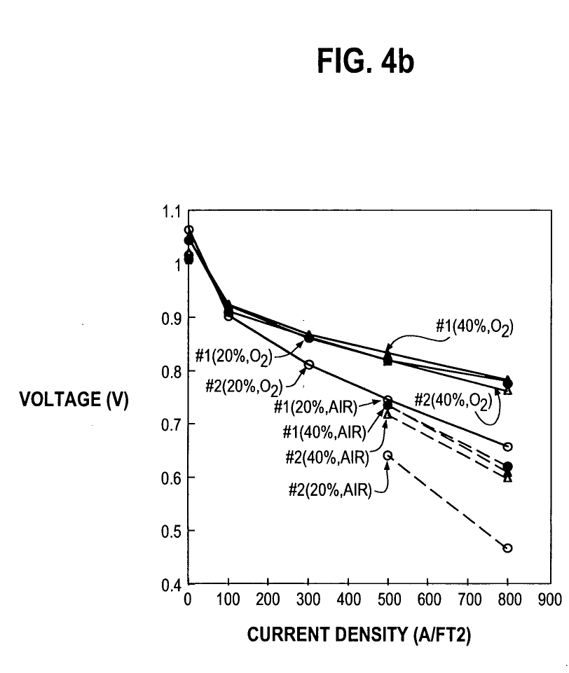

Initially, cells with each of the different platinum loadings were operated in voltage reversal and the time taken to deactivate the carbon supported anode catalyst was determined. The test involved flowing humidified nitrogen over the anode (instead of fuel) while forcing 30A current through the cell using a power supply connected across the fuel cell. However, the power supply limited the cell voltage to be greater than −1.2 volts. When the cell was no longer able to sustain the 30 A current above this voltage limit, the current dropped, and the cell was said to be deactivated. FIG. 4a shows the time to anode deactivation as a function of percentage platinum loading on the support. The higher the percentage, the longer it took to deactivate the anode.

Voltage reversal testing continued for a fixed period of 20 minutes during which time the cells were operated in voltage control mode between about −1.15 and about −1.2 volts. After the initial deactivation, the current was allowed to float and typically was in the range of from 1 to 3 A. Polarization data for the cells with 20% and 40% platinum loading was then obtained again after the reversals to determine the effect of a reversal episode on cell performance. FIG. 4b shows these polarization results. (In FIG. 4b, the cells with 20% and 40% platinum loading are represented by circle and triangle symbols respectively. Results obtained before (#1) and after (#2) reversal testing are indicated by filled and unfilled symbols respectively. Results obtained using air and oxygen are indicated by dashed and solid lines respectively.) The cell with the 20% platinum loaded anode showed a substantial degradation in polarization performance on both oxygen and air after the reversal. The cell with the higher 40% platinum loaded anode however showed little degradation in polarization performance.

This example demonstrates that voltage reversal tolerance is improved with the use of supported catalysts having higher platinum loading.

### EXAMPLE 3

Another series of solid polymer fuel cells was constructed using different carbon supports for the anode catalyst as indicated below. The catalyst samples prepared were:

S—Pt/Ru alloy and RuO₂ supported on Shawinigan acetylene black (from Chevron Chemical Company, Texas, USA), 16% Pt/8% Ru (as alloy)/20% Ru (as RuO₂) by weight.

V—Pt/Ru alloy and RuO₂ supported on Vulcan XC72R grade furnace black (from Cabot Carbon Ltd., South Wirral, UK), 16% Pt/8% Ru (as alloy)/20% Ru (as RuO₂) by weight.

GV—Pt/Ru alloy and RuO₂ supported on graphitized Vulcan XC72R grade furnace black (graphitized at temperatures above 2500° C.), 16% Pt/8% Ru (as alloy)/20% Ru (as RuO₂) by weight.

The order of corrosion resistance of the carbon supports is Vulcan XC72R (graphitised) is greater than Shawinigan, which is greater than Vulcan XC72R. This order of corrosion resistance is related to the graphitic nature of the carbon supports. The more graphitic the support, the more corrosion resistant the support. The graphitic nature of a carbon is exemplified by the carbon inter-layer separation d₀₀₂ measured from the x-ray diffractograms. Synthetic graphite (essentially pure graphite) has a spacing of 3.36 Å compared with 3.45 Å for Vulcan XC72R (graphitised), 3.50 Å for Shawinigan, and 3.56 Å for Vulcan XC72R, with the higher inter-layer separations reflecting the decreasing graphitic nature of the carbon support and the decreasing order of corrosion resistance. Another indication of the corrosion resistance of the carbon supports is provided by the BET surface area measured using nitrogen. Vulcan XC72R has a surface area of 228 m²/g. This contrasts with a surface area of 86 m²/g for Vulcan (graphitised). The much lower surface area as a result of the graphitisation process reflects a loss in the more corrodible microporosity in Vulcan XC72R. The microporosity is commonly defined as the surface area contained in the pores of a diameter less than 20 Å. Shawinigan has a surface area of 55 m²/g, and BET analysis indicates a low level of corrodible microporosity available in this support.

In the preceding samples S, V, and GV, a conventional nominal 1:1 atomic ratio Pt/Ru alloy was deposited onto the indicated carbon support first. This was accomplished by making a slurry of the carbon black in demineralized water. Sodium bicarbonate was then added and the slurry was boiled for thirty minutes. A mixed solution comprising H₂PtCl₆ and RuCl₃ in an appropriate ratio was added while still boiling. The slurry was then cooled, formaldehyde solution was added, and the slurry was boiled again. The slurry was then filtered and the filter cake was washed with demineralised water on the filter bed until the filtrate was free of soluble chloride ions (as detected by a standard silver nitrate test). The filtrate was then oven dried at 105° C. in air, providing 20%/10% Pt/Ru alloy carbon supported samples. Then, a rutile RuO₂ catalyst composition was deposited onto these previously prepared carbon supported Pt/Ru catalyst compositions. This was accomplished by making a slurry of the carbon supported Pt/Ru sample in boiling demineralized water. Potassium bicarbonate was added next and then RuCl₃ solution in an appropriate ratio while still boiling. The slurry was then cooled, filtered and washed with demineralised water as above until the filtrate was free of soluble chloride ions (as detected by a standard silver nitrate test). The filtrate was then oven dried at 105° C. in air until there was no further mass change. Finally, each sample was placed in a controlled atmosphere oven and heated for two hours at 350° C. under nitrogen.

A set of anodes was then prepared using these catalyst compositions for evaluation in test fuel cells. In these anodes, the catalyst compositions were applied in layers in the form of aqueous inks on porous carbon substrates using a screen printing method. The aqueous inks comprised catalyst, ion conducting ionomer, and a binder. The MEAs (membrane electrode assemblies) for these cells employed a conventional cathode having platinum black (that is, unsupported) catalyst applied to a porous carbon substrate, and a conventional Dowpont™ perfluorinated solid polymer membrane. The catalyst loadings on the electrodes were in the range of 0.2-0.3 mg Pt/cm². A fuel cell was prepared using each of the S, V and GV catalyst compositions.

Each cell was conditioned prior to voltage reversal testing by operating it normally at a current density of about 0.5 A/cm² and a temperature of approximately 75° C. Humidified hydrogen was used as fuel and humidified air as the oxidant, both at 30 psig pressure. The stoichiometry of the reactants was 1.5 and 2 for the hydrogen and oxygen reactants respectively. The output cell voltage as a function of current density (polarization data) was then determined. After that, each cell was subjected to a voltage reversal test by flowing humidified nitrogen over the anode (instead of fuel) while forcing 10 A current through the cell for 23 minutes using a constant current power supply connected across the fuel cell.

During the voltage reversal, the cell voltage as a function of time was recorded. The production of CO₂ and O₂ gases were also monitored by gas chromatography and the equivalent currents consumed to produce these gases were calculated in accordance with the preceding reactions for a fuel starvation condition. Polarization data for each cell was obtained after the reversals to determine the effect of a single reversal episode on cell performance.

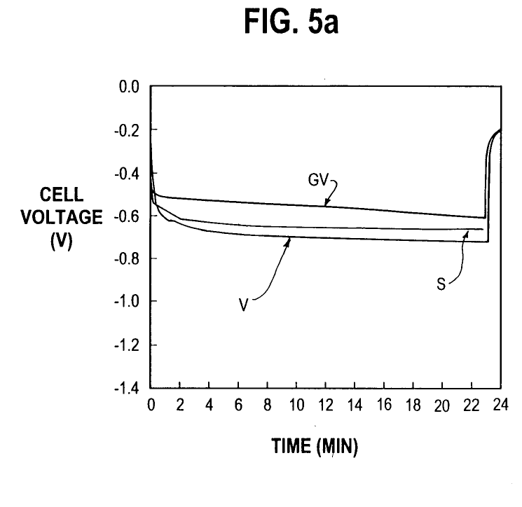

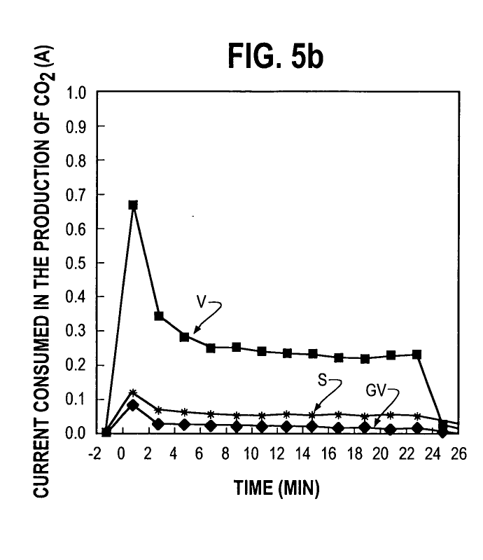

FIG. 5a shows the plots of voltage as a function of time for cells S, V and GV during the voltage reversal period. Cell GV operated at a lower anode potential than cell S during reversal (that is, at a less negative cell voltage) and cell S operated at a lower anode potential than cell V during reversal.

FIG. 5b shows the current consumed in the production of CO₂ as a function of time for the cells during reversal. Cell GV shows less CO₂ production over time than cell S, and cell S shows less CO₂ production over time than cell V. (Note that substantially, the current forced through the cells during reversal testing could be accounted for by the sum of the equivalent currents associated with the generation of CO₂ and O₂Thus, the reaction mechanisms above appear consistent with the test results.)

This example demonstrates that voltage reversal tolerance is improved with the use of more graphitic carbon supports.

While particular elements, embodiments and applications of the present invention have been shown and described, it will be understood, of course, that the invention is not limited thereto since modifications may be made by those skilled in the art without departing from the scope of the present disclosure, particularly in light of the foregoing teachings.

What is claimed is:

1. A fuel cell with improved voltage reversal tolerance, said fuel cell comprising a cathode, an electrolyte, and an anode, and said anode comprising a supported catalyst, wherein the loading of said catalyst on said support is greater than about 40% by weight.

2. The fuel cell of claim 1 wherein said electrolyte is a solid polymer and said fuel cell is a solid polymer electrolyte fuel cell.

3. The fuel cell of claim 1 wherein said catalyst comprises platinum.

4. The fuel cell of claim 1 wherein said support comprises carbon.

5. The fuel cell of claim 4 wherein said support comprises acetylene or furnace carbon black.

6. A fuel cell with improved voltage reversal tolerance, said fuel cell comprising a cathode, an electrolyte, and an anode, and said anode comprising a supported catalyst wherein the catalyst covers greater than about 6% of the surface of said support.

7. The fuel cell of claim 6 wherein the catalyst covers greater than about 9% of the surface of said support.

8. A fuel cell with improved voltage reversal tolerance, said fuel cell comprising a cathode, an electrolyte, and an anode, and said anode comprising a supported catalyst, wherein the catalyst/support interface perimeter is less than about 10¹¹ m per gram of catalyst.

9. The fuel cell of claim 8 wherein the catalyst/support interface perimeter is less than about 4×10¹⁰ m per gram of catalyst.

10. A fuel cell with improved voltage reversal tolerance, said fuel cell comprising a cathode, an electrolyte, and an anode, and said anode comprising a supported catalyst wherein said support is more resistant to oxidative corrosion than carbon black.

11. The fuel cell of claim 10 wherein said support comprises a graphitic carbon characterized by a d₀₀₂ spacing of less than 3.56 Å.

12. The fuel cell of claim 10 wherein said support comprises a graphitic carbon characterized by a d₀₀₂ spacing of about 3.45 Å.

13. The fuel cell of claim 10 wherein said support comprises a graphitic carbon characterized by a BET surface area of less than 230 m²/g.

14. The fuel cell of claim 10 wherein said support comprises a graphitic carbon characterized by a BET surface area of about 86 m²/g.

15. The fuel cell of claim 10 wherein said support comprises Ti₄O₇.

16. A method of making a fuel cell more tolerant to voltage reversal, said fuel cell comprising a cathode, a solid polymer electrolyte, and an anode, and said anode comprising a supported catalyst, wherein said method comprises increasing the loading of said catalyst on said support to be greater than about 40% by weight.

17. A method of making a fuel cell more tolerant to voltage reversal, said fuel cell comprising a cathode, a solid polymer electrolyte, and an anode, and said anode comprising a supported catalyst, wherein said method comprises increasing the catalyst coverage of the surface of said support to be greater than about 6%.

18. The method of claim 17 comprising increasing the catalyst coverage of the surface of said support to be greater than about 9%.

19. A method of making a fuel cell more tolerant to voltage reversal, said fuel cell comprising a cathode, a solid polymer electrolyte, and an anode, and said anode comprising a supported catalyst, wherein said method comprises decreasing the catalyst/support interface perimeter to be less than about 10¹¹ m per gram of catalyst.

20. The method of claim 19 comprising decreasing the catalyst/support interface perimeter to be less than about 4×10¹⁰ m per gram of catalyst.

21. A method of making a fuel cell more tolerant to voltage reversal, said fuel cell comprising a cathode, a solid polymer electrolyte, and an anode, and said anode comprising a supported catalyst, wherein said method comprises employing a support for said catalyst that is more resistant to oxidative corrosion than carbon black.
